(19) United States
(12) Patent Application Publication
(10) Pub. No.: US 2004/0252702 A1
(43) Pub. Date: Dec. 16, 2004

(54) Arbiter circuit

(75) Inventors: Masakuni Kawagoe, Miyazaki (JP); Akihiro Narumi, Miyazaki (JP); Yoshihiro Nakatake, Miyazaki (JP)

Correspondence Address: NIXON PEABODY, LLP, 401 9TH STREET, NW, SUITE 900, WASHINGTON, DC, 20004-2128, US

(73) Assignee: Oki Electric Industry Co., Ltd., Tokyo (JP)

(21) Appl. No.: 10/698,449

(22) Filed: Nov. 3, 2003

(30) Foreign Application Priority Data
May 22, 2003 (JP) 2003-145113

(51) Int. Cl. H04L 12/28

(52) U.S. Cl. 370/395.42

(57) ABSTRACT

An arbiter circuit minimizes the occurrence of malfunctions and permits easy adjustment. The arbiter circuit includes a data transfer request signal holding device for accepting a plurality of data transfer request signals and holding the data transfer request signals in response to predetermined timing signals, a prioritizing device for determining only a signal with the highest priority at a certain point as a valid signal and the signals with lower priorities as invalid signals in order to assign priorities to output signals from the data transfer request signal holding device, and a delaying device for generating data transfer execution signals from the output signals of the prioritizing device. This arrangement restrains the occurrence of errors in assigning priorities to data transfer request signals and permits easy priority timing setting, thus allowing easy adjustment of a circuit to be achieved.

### BACKGROUND OF THE INVENTION

1. Field of the Invention

The present invention relates to access control in a system in which a field memory is accessed by a plurality of apparatuses and, more particularly, to an arbiter circuit for assigning priorities to data transfers between registers for temporarily holding data and memory cells when accessing a memory.

2. Description of the Related Art

Hitherto, a field memory, which is a serial access memory permitting high-speed asynchronous read/write, has registers for read/write operations, respectively, for temporarily holding data to allow high-speed asynchronous read/write to be accomplished. The field memory is further equipped with an arbiter circuit for assigning priorities to data transfers between registers and memory cells so as to protect data from damage when accessing a memory cell of the same address at the same time.

FIG. 1 is a configuration diagram showing a conventional arbiter circuit. The arbiter circuit is constructed of an arbiter unit for assigning priorities to data transfers and a delay unit for securing priority margins and the margins between data transfers. The priority margins refer to the allowances for preventing data transfer errors when data transfer requests from apparatuses are simultaneously received or if a data transfer request from an apparatus with a lower priority is sent out first. The arbiter unit is constructed of arbiter circuits 1 to n, and the delay unit is constructed of delay circuits 1 to n (FIG. 1 shows an example wherein n=3).

The following will briefly describe the meanings of major symbols.

ARBI<0>˜ARBI<2>:Data transfer request signals

END:Data transfer end signal

ARB_N1, ARB_N2:Signal terminals for receiving signals to assign priorities to data transfer request signals

ARBO<0>˜ARBO<2>:Data transfer execution signals

ARB_NO<0>˜ARB_NO<2>:Data transfer request set signals

ST:Initial reset signal generated when power is turned ON.

Switches from “L” level to “H” level in a while after the power is turned ON, then retains the “H” level thereafter.

For the purpose of simplifying explanation, three data transfer request signals will be used, the priorities of the signals being ARBI<0>, ARBI<1> and ARBI<2> in a descending order.

The operation of the conventional arbiter circuit shown in FIG. 1 will be explained in conjunction with the time chart shown in FIG. 5. The time chart shown in FIG. 5 illustrates a case where three data transfer request signals are simultaneously activated. First, ARBI<0>, ARBI<1> and ARBI<2> rise (are enabled). Upon receipt of the signals, nd2 (refer to FIG. 2) among ARB circuit 1 <0> through ARB circuit 1 <2> is latched at the “H” level, the data transfer request set signals ARB_NO<0> through ARB_NO<2> fall (are enabled), and a node nd1 in a DELAY circuit 2 rises (refer to FIG. 4), causing all data transfer requests to be set.

In the ARB circuit 1 <1> and the ARB circuit 1 <2>, the ARB_NO<0> signal output from the ARB circuit 1 <0> is connected to the individual ARB_N1 terminals without delay. Hence, ARB_NO<1> and ARB_NO<2> immediately rise and the nodes nd1 of a DELAY circuit 2<1> and a DELAY circuit 2<2> fall, so that the data transfer execution signals ARBO<1> and ARBO<2>associated with the transfer request signals ARBI<1> and ARBI<2> are not enabled.

The same applies to the ARB circuit 1<0>. The priority assigning terminals ARB_N1 and ARB_N2 are respectively connected to output signals ARB_NI<1> and ARB_NI<2> from the DELAY circuit 1 associated with ARB_NO<l> and ARB_NO<2>; therefore, an attempt is made to reset the ARB circuit 1<0> with a delay time imparted by the DELAY circuit 1<1> and the DELAY circuit 1<2>. However, the ARB circuit 1<0> will not be reset, because the ARB_NO<1> and ARB_NO<2> of the ARB circuit 1<1> and the ARB circuit 1<2> have already been reset. This causes an ARBOB<0> signal to rise, being delayed by inverters DINV1 and DINV2 from the rise of the node nd1 shown in FIG. 4. Thus, the data transfer execution signal ARBO<0> falls and is activated (or enabled).

Momentarily, the signals of ARB_NO<l> and ARB_NO<2> switch to the “L” level, and the nodes nd1 of the DELAY circuit 2<1> and the DELAY circuit 2<2> switch to the “H” level. Regarding ARB_NO<1> and ARB_NO<2>, setting a sufficiently large value for the time constants of resistor R1 and capacitor C1 of the DELAY circuit 1<1> and the DELAY circuit 1<2> prevents a pulse-shaped signal from being output from OUT terminals, so that ARB_NI<1> and ARB_NI<2> maintain the “H” level. In the DELAY circuit 2<1> and the DELAY circuit 2<2>, no pulse-shaped signals will be output, because the ARB_NO<1> and ARB_NO<2> signals are sufficiently delayed in relation to nd1 signal. As a result, the data transfer execution signals ARBO<l> and ARBO<2> are maintained at the “H” level (disabled).

Subsequently, an END signal indicating that the data transfer in response to the data transfer request signal ARBI<0> has been completed is switched to the “H” level. At this time, ARBEND<0> signal (refer to FIG. 2) of the ARB circuit 1<0> is switched to the “L” level, while the ARB_NO<0> signal is switched to the “H” level. This causes the data transfer execution signal ARBO<0> to rise through the DELAY circuit 2<0> and is deactivated (disabled).

In the ARB circuit 1<1> and the ARB circuit 1<2>, as long as the END signal is maintained at the “H” level, ARBOB<1> and ARBOB<2> signals are maintained at the “L” level. This means that ARBEND<1> and ARBEND<2> signals will not rise; therefore, the state in which nd2 shown in FIG. 2 is latched at the “H” level continues. Thus, in response to the fall of the ARB_NO<0> signal, the ARB_NO<1> and ARB_NO<2> signals fall, while the node nd1 of the DELAY circuit 2<1> and the DELAY circuit 2<2> rise, and the remaining two data transfer requests are set.

In the ARB circuit 1<1> also, since ARB_NI<2> is connected to ARB_N2, the ARB circuit 1<1> attempts to be reset with a delay time imparted by the DELAY circuit 1<2>. This attempt of reset is invalid because the ARB circuit 1<2> has already been reset. As a result, in the DELAY circuit 2<1>, ARBOB<1> rises, delaying by a delay time imparted by the inverter circuits DINV1 and DINV2 from the rise of nd1, while the data transfer execution signal ARBO<1> falls and is activated (enabled).

Momentarily, the signal ARB_NO<2> switches to the “L” level, and the nodes nd1 of the DELAY circuit 2<2> switches to the “H” level. The pulse signal ARB_NO<2> is absorbed due to the delay related to the time constants of C and R of the DELAY circuit 1<2>. Therefore, the signal ARB_NI<2> maintains the “H” level. The signal nd1 of the DELAY circuit 2<2> is absorbed due to the delay time imparted by the inverter circuits DINV1 and DINV2 of the DELAY circuit 2<2>, and not output. The signal ARBO<2> maintains the “H” level.

At the fall of the second END signal, the ARB circuit 1<1> performs the same operation as that of the ARB circuit 1<0> at the rise of the first END signal, while the ARB circuit 1<2> performs the same operation as that of the ARB circuit 1<1> at the fall of the first END signal.

At the fall of the third END signal, the ARB circuit 1<2> performs the same operation as that of the ARB circuit 1<0> at the rise of the first END signal.

In the conventional arbiter circuit shown in FIG. 1 through FIG. 4, when three data transfer request signals are simultaneously activated, the data transfer execution signals are activated (enabled) in a descending order of priority by making use of the delay time supplied by the DELAY circuit 1, as described above.

However, according to the conventional circuit configuration shown in FIG. 1 through FIG. 4, when a data transfer request signal with a high priority and a data transfer request signal with a low priority are simultaneously activated, the priority of the next data transfer is determined on the basis of the delay time of the DELAY circuit 1 and the delay time of the inverter circuits DINV1 and DINV2 of the DELAY circuit 2. Hence, variations in the delay amount caused by variations in process or variations in wiring load or the like may cause malfunctions of attributable to a time change between transfers or errors, such as priority switching.

Furthermore, as the number of data transfer request signals increases, it is necessary to add the number of the ARB circuits and the DELAY circuits for determining the priorities of data transfer request signals. This has presented a problem of an increased layout area for fabricating an integrated circuit and another problem in that the transfer-to-transfer time must be set for each transfer operation with a resultant complicated timing adjustment.

### SUMMARY OF THE INVENTION

Accordingly, it is an object of the present invention to provide an arbiter circuit that minimizes chances of malfunction and permits easy adjustment. To this end, the arbiter circuit in accordance with the present invention includes a data transfer request signal holding device for accepting a plurality of data transfer request signals and holding the data transfer request signals in response to predetermined timing signals, a prioritizing device for determining only a signal with the highest priority at a certain point as a valid signal and the signals with lower priorities as invalid signals in order to assign priorities to output signals from the data transfer request signal holding device, and a delaying device for generating data transfer execution signals from the output signals of the prioritizing device. This arrangement minimizes errors in assigning priorities to data transfer request signals and permits easy priority timing setting, thus allowing easy adjustment of a circuit to be achieved.

### BRIEF DESCRIPTION OF THE DRAWINGS

FIG. 1 is a configuration diagram of a conventional arbiter circuit;

FIG. 2 is an ARB circuit of the conventional arbiter circuit;

FIG. 3 is a DELAY circuit 1 of the conventional arbiter circuit;

FIG. 4 is a DELAY circuit 2 of the conventional arbiter circuit;

FIG. 5 is a time chart for explaining the operation of the conventional arbiter circuit;

FIG. 6 is a block diagram showing the entire configuration of a first specific example of the present invention;

FIG. 7 is a circuit configuration of an arbiter unit in the first specific example;

FIG. 8 is a diagram showing a specific example of a DELAY circuit of a delay unit in the first specific example;

FIG. 9 is a time chart for explaining the operation of a circuit in the first specific example;

FIG. 10 is a block diagram showing the entire configuration of a second specific example;

FIG. 11 is a diagram showing a specific example of a DELAY circuit of a delay unit in the second specific example; and

FIG. 12 is a diagram showing a specific example of a DELAY circuit of a delay unit in a third specific example.

### DESCRIPTION OF THE PREFERRED EMBODIMENTS

The following will provide detailed explanation of specific examples of the present invention with reference to the accompanying drawings.

[First Specific Example]

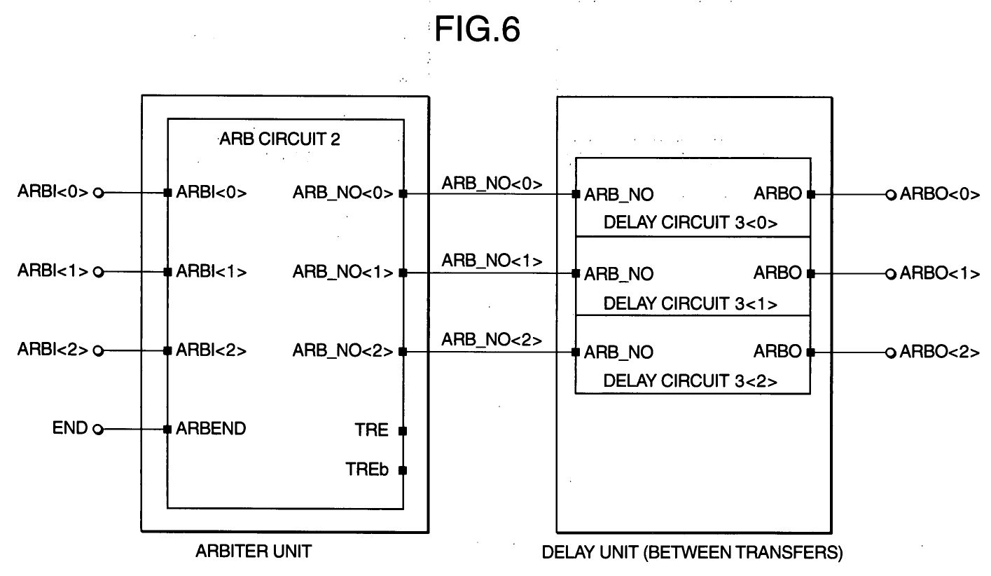

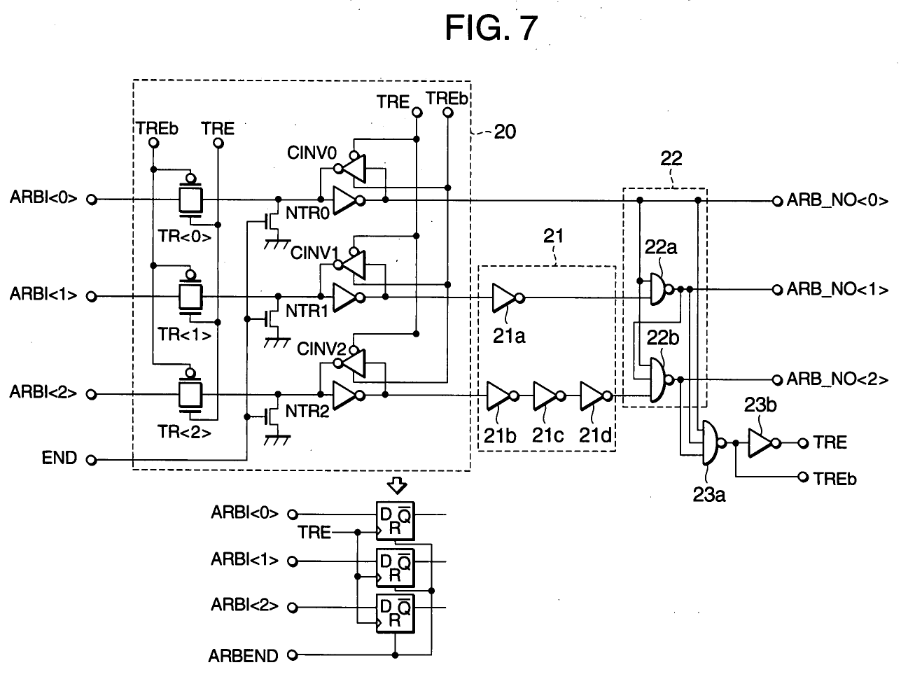

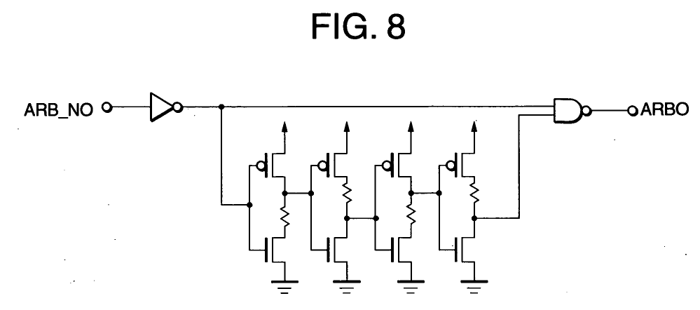

FIGS. 6 through 8 show the configuration of an arbiter circuit in a first specific example according to the present invention. For the purpose of simplifying the explanation, the number of data transfer request signal lines will be three, as in the case of the conventional example. FIG. 6 shows the entire configuration of the first specific example, FIG. 7 shows the circuit configuration of an arbiter unit, and FIG. 8 shows a specific example of a DELAY circuit of a delay unit.

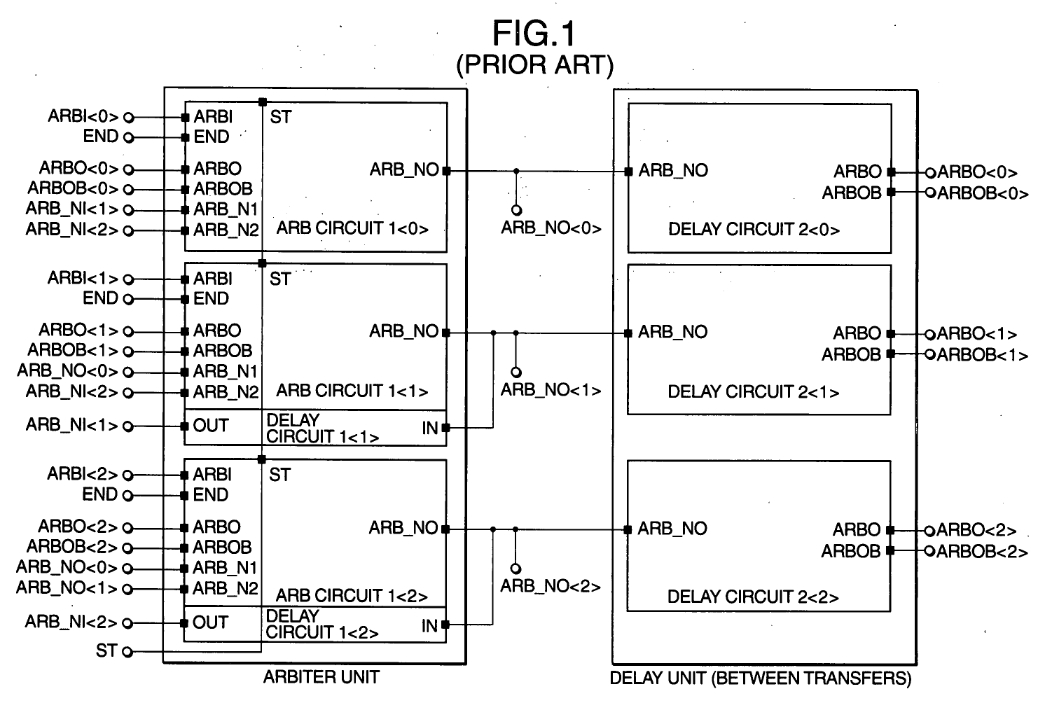

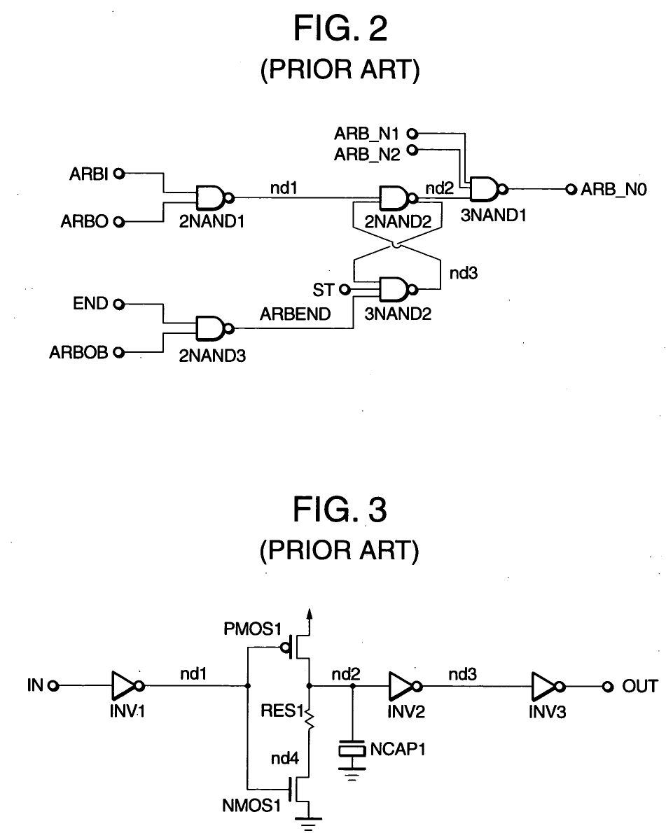

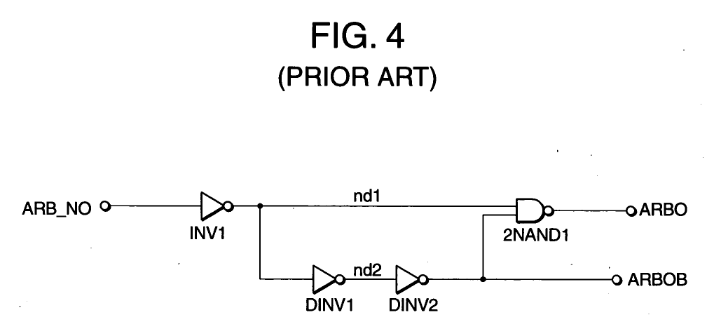

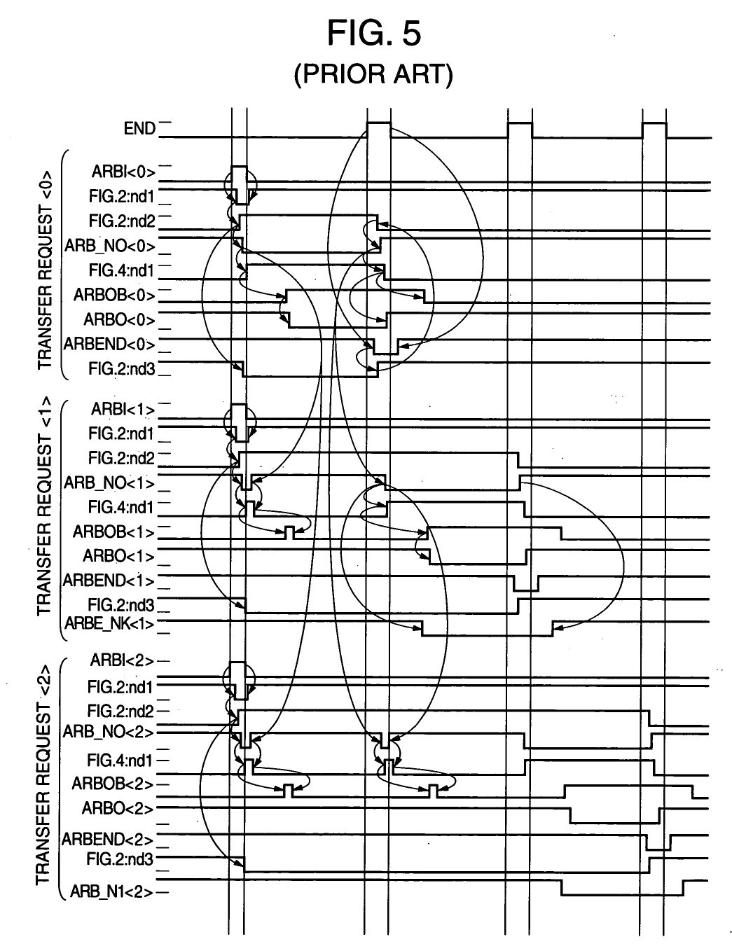

FIG. 6 shows the entire configuration of the arbiter circuit in the first specific example. The arbiter circuit has an ARB circuit 2 to replace the ARB circuit 1 and the DELAY circuit 1 of the arbiter unit of the conventional example shown in FIG. 1. The ARB circuit 2 logically selects and outputs data transfer request signals according to priorities. The arbiter circuit further includes a DELAY circuit 3 for preventing reversal of priorities and for securing margins between data transfers.

The following will briefly describe the meanings of major symbols in the first specific example.

ARBI<0>, ARBI<1>, ARBI<2>:Data transfer request signals

ARB_NO<0>, ARB_NO<1>, ARB_NO<2>:Data transfer request set signals

ARBOB<0>, ARBOB<1>, ARBOB<2>:Data transfer execution signals

TRE/TREb:Transfer enable signals for controlling the blocking, transfer and latching of data transfer request signals

ST: Initial reset signal generated when power is turned ON.

Switches from “L” level to “H” level in a while after the power is turned ON, then retains the “H” level thereafter.

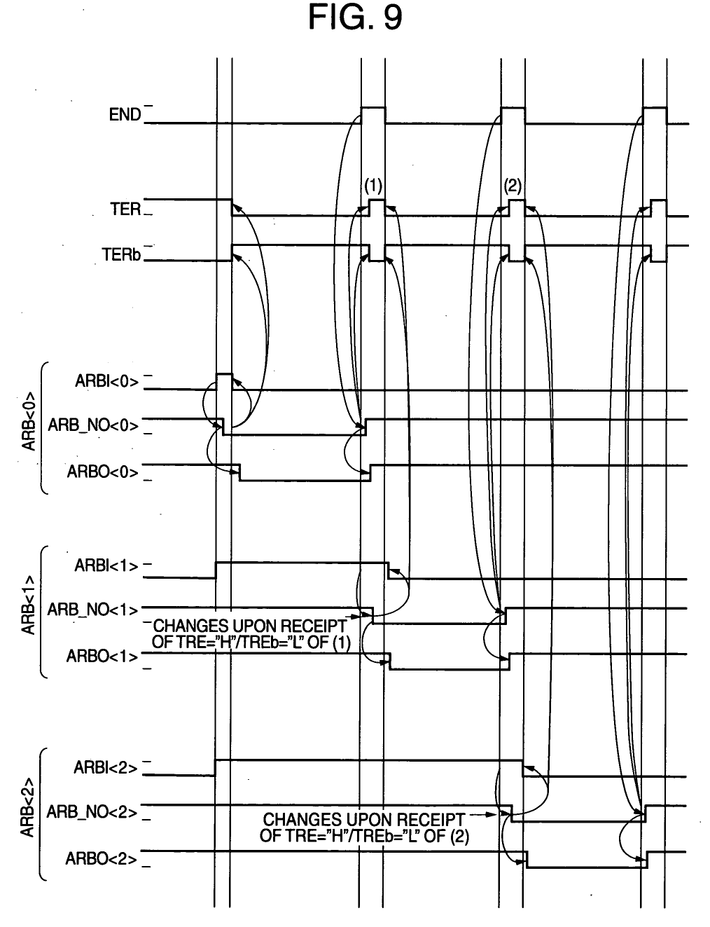

The operation of the arbiter circuit in the first specific example will be explained in conjunction with the time chart shown in FIG. 9. As in the case illustrated in FIG. 1, the description will be given of a case where three data transfer request signals ARBI<0> through ARBI<2> are simultaneously activated.

The transfer enable signals TRE/TREb are set at “H/L” levels, respectively, so that transfer gates TR<0> through TR<2> are all ON, and the inputs of ARBI<0> through ARBI<2> are held at data holding circuits CINV0 through CINV2 respectively composed of a pair of inverters. NTR0 through NTR2 denotes circuits for resetting the data held at the data holding circuits. Thus, TR<0> through TR<2>, NTR0 through NTR2, and CINV0 through CINV2 make up three flip-flop circuits (data transfer request holding devices) 20 that receive ARBI<0> through ARBI<2> as input data, use the TRE signal as the trigger signal, and use the ARBEND signal as the reset signal.

The priorities of the data transfer request signals ARBI<0> through ARBI<2> are set in the descending order, ARBI<0> having the highest priority. Based on the priorities, the data transfer request set signal ARB_NO<0> of the highest priority is activated (switched to the “L” level) first. This signal is output from a prioritizing circuit (prioritizing device) 22 composed of gate circuits 22a and 22b. Upon receipt of the activated signal ARB_NO<0>, the signals ARB_NO<1> and ARB_NO<2> with lower priorities are masked by the aforesaid gate circuits 22a and 22b, respectively, so that they are not output (“H” level).

Referring to FIG. 7, a circuit (signal delay device) 21 composed of an inverter circuit 21a and inverter circuits 21b through 21d connected in series is inserted between the foregoing data transfer request holding device and the prioritizing device. The circuit 21 assures circuit operation in case a data transfer request signal with a lower priority is input before a signal with a higher priority. If such a case does not happen, then the circuit 21 is not necessarily required.

The activation of the signal ARB_NO<0> causes the TRE signal and the TREb signal to be switched to the “L” level and the “H” level, respectively, by gate circuits 23a and 23b. The transfer gates TR<0> through TR<2> blocks the inputs of the data transfer request signals ARBI<0> through ARBI<2>, and the holding circuits CINVO through CINV2 respectively latch the current statuses.

Immediately after the latching operation, the signal ARBI<0> is reset to the “L” level. The activated signal ARBI<0> causes the signal ARBO<0>, which is the data transfer execution signal, to fall after a preset delay time in a DELAY circuit 3<0>, thus carrying out the data transfer. Upon completion of the data transfer, the END signal is switched to ON (“H” level). This causes NMOS transistors NTR0 through NTR2 to turn ON, the signals ARBO<0> through ARBO<2> to be switched to the “H” level, and the ARB circuit 2 to be reset.

Upon receipt of the reset signal ARB_NO<0> at the “H” level, the signals TRE and TREb are switched to the “H” level and the “L” level, respectively, and the transfer gates TR<0> through TR<2> of the circuit shown in FIG. 7 are set to ON. This permits the input of the data transfer request signals ARBI<0> through ARBI<2>, and the next data transfer request signal will be enabled on the basis of priorities (ARBO<1> is activated in this case). Similarly, the signals up to ARBO<2> are activated to execute all transfers.

As described above, in this specific example, the priorities of data transfer request signals are logically determined by the prioritizing device. This arrangement makes it possible to reduce changes attributable to process variations, as compared with the conventional method for determining priorities by signal delays by using the DELAY circuit 1 and the DELAY circuit 2, thus permitting malfunctions to be restrained, and the priority timing setting to be easier.

[Second Specific Example]

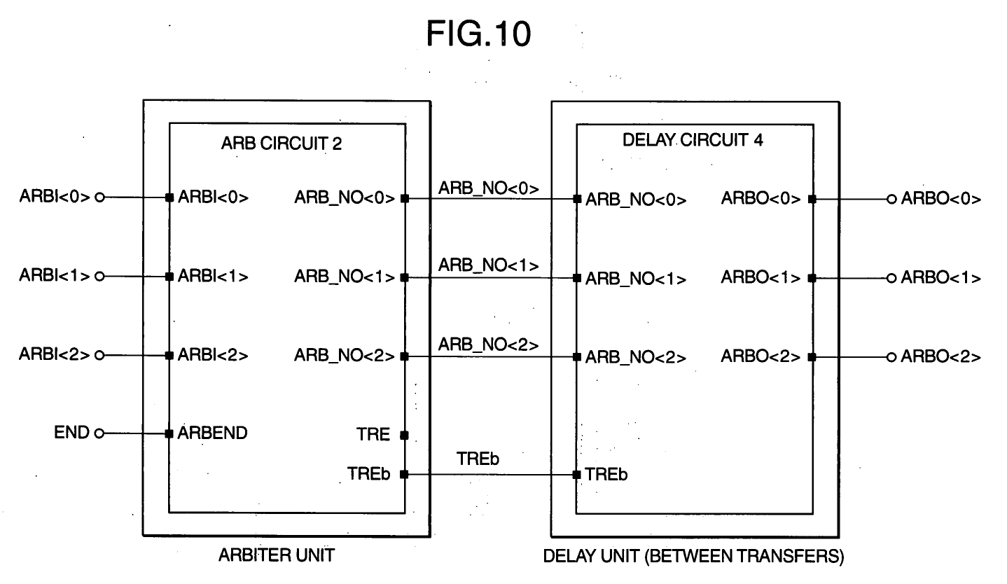

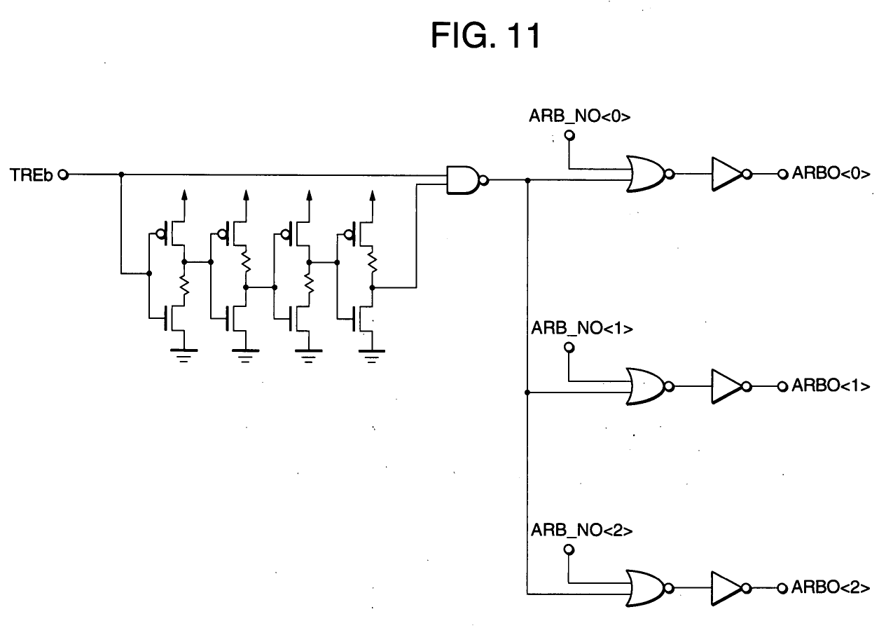

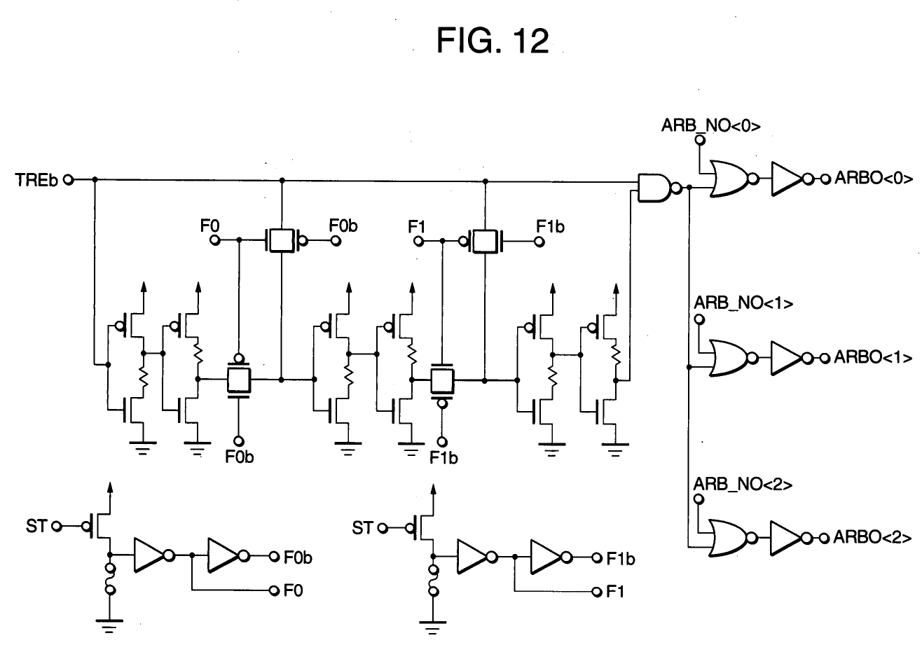

FIG. 10 is a block diagram showing the entire configuration of a second specific example of the present invention, and FIG. 11 shows a specific example of a circuit diagram of a DELAY circuit 4 in the second specific example. In this specific example, the ARB circuit 2 shown in FIG. 10 is the same as the circuit in the first specific example, whereas the DELAY circuit 4 has an integrated single circuit configuration rather than being provided for each of the data transfer request set signals ARB_NO<0> through ARB_NO<2>. The specific example shown in FIG. 11 illustrates the DELAY circuit 4 in detail.

A description will be given of only the aspect of the circuit operation in the second specific example that differs from the operation in the first specific example.

Upon receipt of the TREb signal (refer to FIG. 7) generated in response to one of the signals ARB_NO<0> through ARB_NO<2> that has been activated in the ARB circuit 2, the data transfer execution signal ARBO<0> is eventually activated by the logic OR with ARB_NO<0> after the delay time preset by the DELAY circuit 4. The rest of the operation is identical to the operation in the first specific example.

Thus, according to this specific example, as compared with the DELAY circuit 3 in the first specific example, there is no need to provide the circuit for each signal ARB_NO, permitting a reduced layout area to be achieved. This advantageously makes it possible to restrain an increase of a chip area when the number of transfer request signals is increased.

[Third Specific Example]

The arbiter unit in a third specific example is identical to those in the first and second specific examples. The DELAY unit basically shares the same configuration as that in the second specific example except that the circuit for setting delay time is provided with a fuse to permit more detailed setting of delay time. The operation of the circuit is the same as that in the second specific example.

As described above, according to the third specific example, more detailed setting of delay time in the DELAY unit can be accomplished, so that the variations in delay amount attributable to variations in process can be advantageously absorbed on the device.

The present invention is not limited to the specific examples described above, and the invention can be embodied in various modifications within the scope of the inventive concept thereof. For instance, in the foregoing specific examples, the three data transfer request signals have been used; however, the present invention can be applied to other cases regardless of the number of the signals. Furthermore, although the description has been made of the cases where the delay device is formed of the resistors combined with inverter circuits, the present invention is not limited thereto. Various other modifications are possible, including a combination of resistors and capacitors or a combination of discrete capacitors and inverter circuits.

As explained above in detail, the arbiter circuit according to the present invention has a data transfer request signal holding device for accepting a plurality of data transfer request signals and holding the data transfer request signals in response to predetermined timing signals, a prioritizing device for determining only a signal with the highest priority at a certain point as a valid signal and the signals with lower priorities as invalid signals in order to assign priorities to output signals from the data transfer request signal holding device, and a delaying device for generating data transfer execution signals from the output signals of the prioritizing device. This arrangement restrains the occurrence of errors in assigning priorities to data transfer request signals and permits easy priority timing setting, thus allowing easy adjustment of a circuit to be achieved.

What is claimed is:

1. An arbiter circuit comprising: data transfer request signal holding means for accepting a plurality of data transfer request signals and holding the data transfer request signals in response to predetermined timing signals;
prioritizing means for determining only a signal with the highest priority at a certain point as a valid signal and the signals with lower priorities as invalid signals in order to assign priorities to output signals from the data transfer request signal holding means; and
delaying means for generating data transfer execution signals from the output signals of the prioritizing means.

2. The arbiter circuit according to claim 1, further comprising a signal delaying means located between the data transfer request signal holding means and the prioritizing means.

3. The arbiter circuit according to claim 2, wherein the signal delaying means comprises a plurality of stages of inverter circuits connected in series, more stages of the signal delaying means being provided for the data transfer request signals with lower priorities.

4. The arbiter circuit according to claim 1, wherein the timing signals are generated on the basis of the output signals of the prioritizing means.

5. The arbiter circuit according to claim 1, wherein the delaying means is provided for each output signal of the prioritizing means.

6. The arbiter circuit according to claim 1, wherein the delaying means is provided for the signal recognized as the signal with the highest priority at that point among the output signals of the prioritizing means.

7. The arbiter circuit according to claim 1, wherein the data transfer request signal holding means comprises a plurality of flip-flop circuits that accepts a plurality of data transfer request signals as input data and has trigger signals (TRE) and reset signals (ARBEND).

8. The arbiter circuit according to claim 1, wherein the prioritizing means comprises a gate circuit that receives the signals output from the data transfer request signal holding means and the delay signals therefor.

9. The arbiter circuit according to claim 1, wherein the delaying means comprises a delay circuit to which an even number of stages of delay inverter circuits connected in series is connected, the delay inverter circuits comprising PMOS transistors, resistors and NMOS transistors, and a circuit that inputs an inversion signal obtained by subjecting an output signal of the prioritizing means to logic inversion to the delay circuit, and takes the logic product of the output signal from the delay circuit associated with the inversion signal, and the inversion signal.

10. The arbiter circuit according to claim 1, wherein the delaying means comprises a delay circuit having an even number of stages of delay inverter circuits connected in series, the delay inverter circuits comprising PMOS transistors, resistors and NMOS transistors, and generates the data transfer execution signals from the timing signals and the output signals of the prioritizing means.

11. The arbiter circuit according to claim 10, wherein the delaying means comprises a plurality of delay circuits to which a plurality of stages of delay inverter circuits are connected in series, the delay inverter circuits comprising PMOS transistors, resistors and NMOS transistors, and further comprises means for enabling/disabling the operations of the plurality of delay circuits.
